(19) United States
(12) Patent Application Publication
(10) Pub. No.: US 2022/0070979 A1
(43) Pub. Date: Mar. 3, 2022

(54) IMPROVED INDUCTION COOKING SYSTEM

(71) Applicant: FABITA S.R.L., Serra San Quirico (IT)

(72) Inventors: Davide ADRIANO, Torino (IT); Gabriele ADRIANO, Torino (IT)

(73) Assignee: FABITA S.R.L., Serra San Quirico (IT)

(21) Appl. No.: 17/421,528

(22) PCT Filed: Dec. 6, 2019
(86) PCT No.: PCT/IT2019/000111

§ 371 Date: Jul. 8, 2021

(30) Foreign Application Priority Data
Jan. 11, 2019 (IT) 102019000000427

(51) Int. Cl. H05B 6/06; H05B 6/12; F24C 15/10

(52) U.S. Cl. CPC H05B 6/062; F24C 15/104; F24C 15/103; H05B 6/1209

(57) ABSTRACT

An induction cooking system (1) with flexible configuration is described, comprising: a mobile cooker assembly (2) only comprising an induction cooking plane (3); a control station (5) comprising control means connected to the induction cooking plane (3) through respective connecting means (7) for transmitting operating electric energy to the induction cooking plane (3), the control means being equipped with processing means programmed to drive and manage the induction operation of the cooking plane (3) through the respective connecting means (7), which is a flexible electric transmission cable.

The present invention refers to an improved induction cooking system.

A great number of induction cookers, of the so-called “free-standing” type, are known in the art, namely of a type composed of a single structure embedding one or more induction cooking planes and their related electric and electronic systems to control the operation and the electric supply both from mains and from a battery.

However, given their specific arrangement, such known cookers are relatively encumbrant on shelves and on working planes, above all in a kitchen (therefore, sometimes, they are designed to be hanged on a wall even if also in such situation they remain heavy and scarcely capable of being handled) and they are poorly suited to the flexibility of use required by different cooking situations (for example, when cooking vessels have big sizes, which often generates an overlapping of the vessel to many cooking planes, necessarily adjacent, since arranged in a fixed position on the same cooker).

Documents DE-A1-10 2006 039087, WO-A1-2018/153505, EP-A1-2 790 467 and EP-A1-3 082 380 disclose induction cooking systems according to the preamble of claim 1.

Therefore, object of the present invention is solving the above prior art problems, by providing an improved induction cooking system which allows a greater flexibility of use with respect to prior art cookers.

Another object of the present invention is providing an improved induction cooking system which allows easily exploiting different cooking planes, even using big-sized cooking vessels.

Moreover, an object of the present invention is providing an improved induction cooking system which allows reducing and/or optimizing the spaces occupied on the working plane with respect to prior art stations.

The above and other objects and advantages of the invention, as will result from the following description, are obtained with an induction cooking system as claimed in claim 1.

Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention, as appears in the enclosed claims.

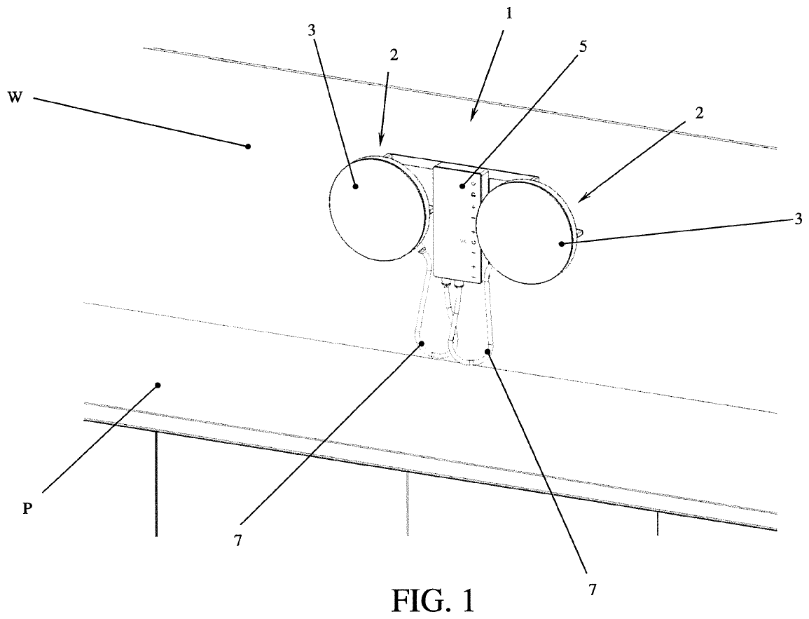

The present invention will be better described by some preferred embodiments thereof, provided as a non-limiting example, with reference to the enclosed drawings, in which FIGS. 1, 2 and 3 show perspective views of a preferred embodiment of the induction cooking system according to the present invention in various operating positions.

With reference therefore to the Figures, it is possible to note that the induction cooking system 1 according to the present invention comprises:
at least one mobile cooker assembly 2 comprising at least one induction cooking plane 3;
at least one control station 5 comprising control means connected to at least one of such induction cooking planes 3 through at least one respective connecting means 7 for transmitting operating electric energy to at least one of such induction cooking planes 3, for example withdrawing electric power coming from an electric supply mains.

In particular, the control station 5 can be equipped with processing means programmed to drive and manage the induction operation of at least one cooking plane 3 through the respective connecting means 7.

The connecting means 7 can further be aimed to the transmission of control signals of the operation of at least one induction cooking plane 3 from such control means.

In a preferred embodiment of the system 1 according to the present invention, the control station 5 is aimed to be connected to a wall W through suitable fastening means, such as, for example, dowels, nails, screws, adhesives, glues, etc., for example next to a working plane P.

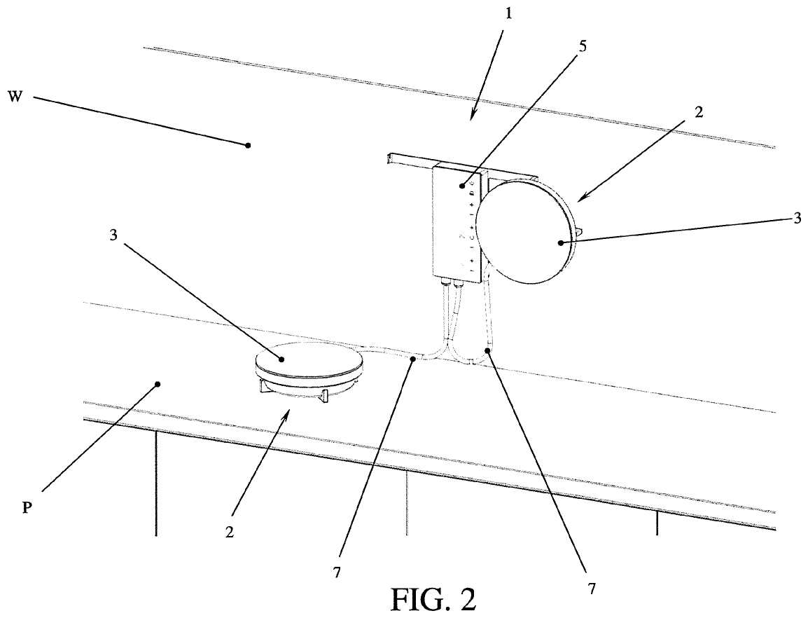

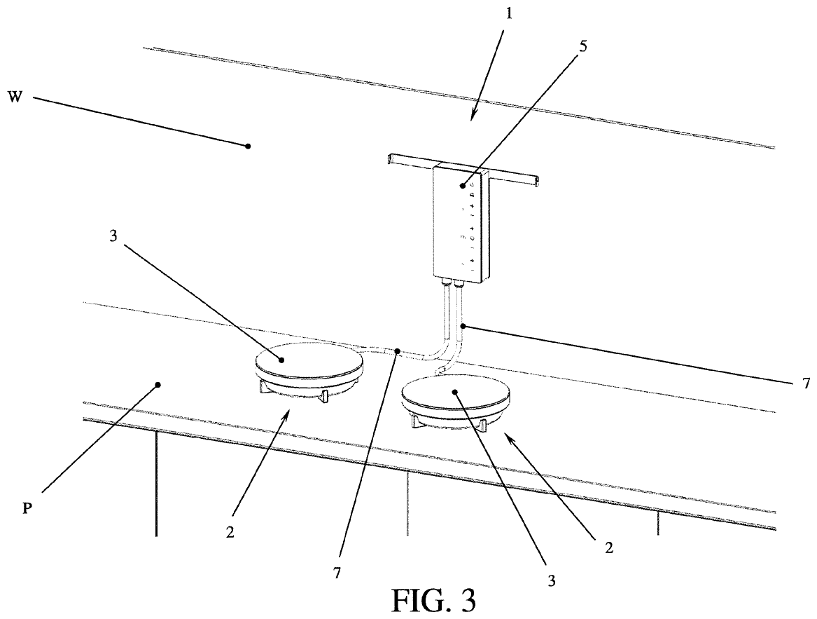

As it is possible to note from the Figures, each possible mobile cooker assembly 2 of the system 1 according to the present invention can then both be individually placed on the working plane P (FIGS. 2 and 3) and be connected or hanged to the control station 5 (FIGS. 1 and 2), through suitable connecting means with which the control station 5 is equipped, to recover space on the working plane P according to the user's needs.

Obviously, it is also possible to provide that the control station can be connected to the working plane P, always for example through suitable fastening means, such as dowels, nails, screws, adhesives, glues, etc., or simply rested onto the working plane P itself.

The connecting means 7 can be, preferably, at least one flexible electric transmission cable with a suitable length.

Obviously, the number of cooker assemblies 2 of the system 1 according to the present invention can be various, without however departing from the scope of the present invention.

Similarly, also the number of induction cooking planes 3 arranged on every mobile cooker assembly 2 can be various, without however departing from the scope of the present invention.

The induction cooking system 1 according to the present invention as described above therefore allows obtaining the pre-set objects.

In fact, advantageously, the mobile cooker assembly 2 is simpler, lighter and handlier with respect to the “free-standing” induction cookers of the prior art, since all control and management components are transferred in the control means placed in the control station 2.

Moreover, the same control station 2 with its related control means can manage the operation of a variable number, even high, of cooker assemblies 2 and of their related induction cooking planes 3.

Moreover, due to a suitable flexibility and length of the transmission cable composing the connecting means 7, the related mobile cooker assembly 2 can be arranged on the working plane P in the most suitable and comfortable position for a user.

Moreover, in case of presence of many mobile cooker assemblies 2, always due to the suitable flexibility and length of the transmission cables composing the related connecting means 7, the same mobile cooker assemblies 2 can be mutually arranged in the most suitable positions, allowing to make extremely versatile configurations of the placements of the respective induction cooking planes 3.

Moreover, differently from prior art cooker assemblies comprising many fixed induction cooking planes, in which possible big-sized cooking vessels (pots, pans, trays, bedpans, etc.) could occupy many of such cooking planes, in a system 1 according to the present invention comprising many cooker assemblies 2, these latter ones can be suitably placed to space, according to needs, the respective induction cooking planes 3, consequently allowing the distinct use of a single one of such induction cooking planes 3 even by a big-sized cooking vessel without uselessly engage also the other possible induction cooking planes 3 of the system 1.

1. An induction cooking system with a flexible configuration, comprising:
at least one mobile cooker assembly comprising only an induction cooking plane; and
at least one control station comprising control means connected to at least one of said induction cooking planes through at least one respective connecting means for transmitting operating electric energy to at least one of said induction cooking planes, said control means being equipped with processing means programmed to drive and manage an induction operation of at least one of said cooking planes through said respective connecting means, said connecting means being at least one flexible electric transmission cable.

2. The induction cooking system according to claim 1, wherein said connecting means are aimed to transmit control signals of the operation of at least one of said induction cooking planes to said control means.

3. The induction cooking system according to claim 1, wherein said control station is connected to a wall.

4. The induction cooking system according to claim 3, wherein said control station is connected to a wall next to a working plane.

5. The induction cooking system according to claim 1, wherein said control station is connected to or rested on a working plane.

6. The induction cooking system according to claim 2, wherein said control station is connected to a wall.

7. The induction cooking system according to claim 2, wherein said control station is connected to or rested on a working plane.
